(19) United States
(12) Patent Application Publication
(10) Pub. No.: US 2003/0225631 A1
(43) Pub. Date: Dec. 4, 2003

(54) System and method for pre-configuration using after point of sale information

(76) Inventors: James A. Howell JR., Georgetown, TX (US); Thomas Vrhel JR., Austin, TX (US); Shree Dandekar, Austin, TX (US)

Correspondence Address: HAMILTON & TERRILE, LLP, P.O. BOX 203518, AUSTIN, TX, 78720, US

(21) Appl. No.: 10/158,981

(22) Filed: May 30, 2002

(51) Int. Cl. G06F 17/60

(52) U.S. Cl. 705/27

(57) ABSTRACT

The invention relates to a system for preconfiguring an information handling system which includes: a configurator, a registration and customization module, a store registration and customization information module and a database. The configurator configures a system with options selected according to user input. Information relating to registration and customization is obtained by the registration and customization module for the information handling system. The store registration and customization information module stores the information relating to the registration and customization on the information handling system. The database receives from and supplies information to the configurator, the registration and customization module and the store registration and customization information module. Further, the invention relates to a method of preconfiguring an information handling system which configures a system with options selected according to user input. Information is obtained relating to registration for the information handling system. The information relating to the registration is stored in a database and loaded from the database onto a particular information handling system while fabricating the particular information handling system. Also, the invention relates to a system configuration store for preconfiguring an information handling system which includes means for configuring a system with options selected according to user input; means for obtaining information relating to registration information for the information handling system; means for storing the information relating to the registration information in a database; and, means for loading the information relating to registration information from the database onto a particular information handling system while fabricating the particular information handling system.

### BACKGROUND OF THE INVENTION

1. Field of the Invention

The present invention relates to build to order systems, and more particularly, pre-configuring a system using after point of sale information.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to order information handling systems either via the telephone or over the internet. It is also known to custom configure systems that are ordered via either method.

### SUMMARY OF THE INVENTION

In accordance with the present invention, pre-configuring an information handling system with registration or customization information is described.

In one embodiment, the invention relates to a system for preconfiguring an information handling system which includes: a configurator, a registration and customization module, a store registration and customization information module and a database. The configurator configures a system with options selected according to user input. Information relating to registration and customization is obtained by the registration and customization module for the information handling system. The store registration and customization information module stores the information relating to the registration and customization on the information handling system. The database receives from and supplies information to the configurator, the registration and customization module and the store registration and customization information module.

In another embodiment, the invention relates to a method of preconfiguring an information handling system which configures a system with options selected according to user input. Information is obtained relating to registration for the information handling system. The information relating to the registration is stored in a database and loaded from the database onto a particular information handling system while fabricating the particular information handling system.

In another embodiment, the invention relates to a system configuration store for preconfiguring an information handling system which includes means for configuring a system with options selected according to user input; means for obtaining information relating to registration information for the information handling system; means for storing the information relating to the registration information in a database; and, means for loading the information relating to registration information from the database onto a particular information handling system while fabricating the particular information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows access to a system configuration store.

FIG. 2 shows a system block diagram of an information handling system.

FIG. 3 shows a schematic block diagram of the operation of the system configuration store FIG. 4 shows a schematic block diagram of the system configuration store.

FIG. 5 shows a flow diagram of the configuration of an information handling system to include the customization features.

### DETAILED DESCRIPTION

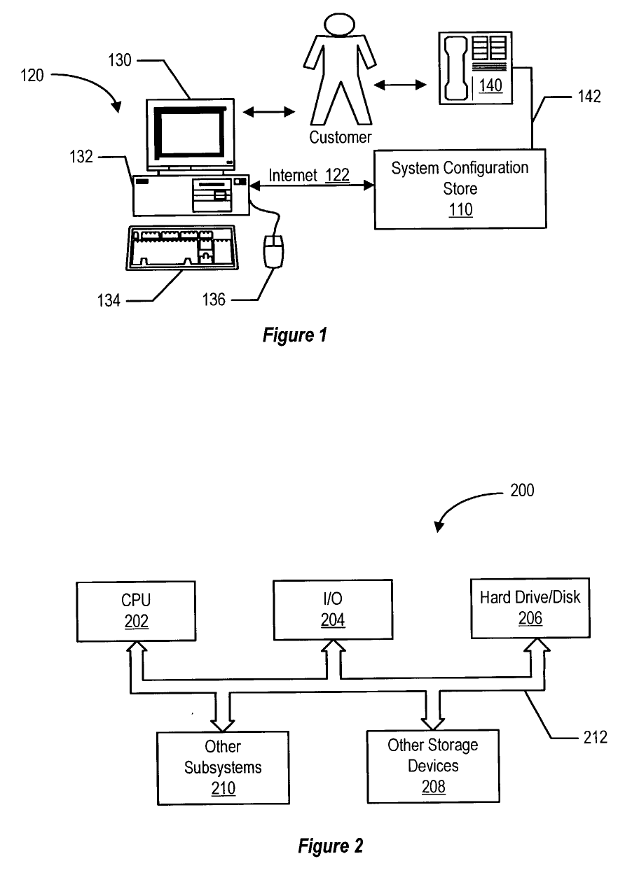

Referring to FIG. 1, a customer can access the system configuration store 110 using any suitable computer equipment 120, via the Internet 122. The computer equipment 120 may include a display 130, computer 132, keyboard 134, and pointing device 136. Display 130 is used for displaying the various pages of the on-line store while a customer is using the on-line store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system.

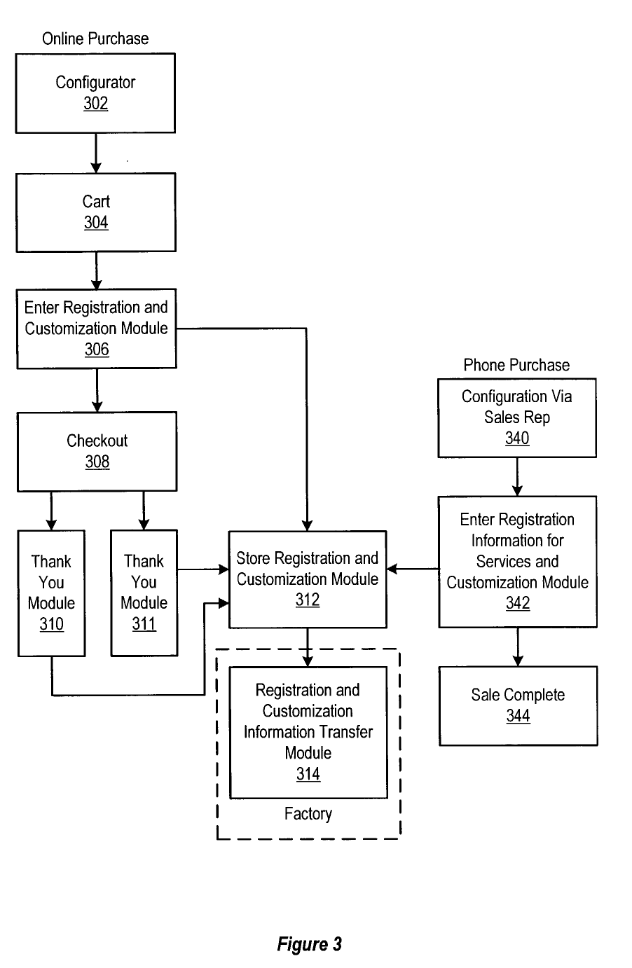

Referring to FIG. 2, a system block diagram of an information handling system 200 is shown having features thereof configured in accordance with the system configuration store 110 as discussed herein. The information handling system 200 includes a processor 202, input/output (I/O) devices, such as a display, a keyboard, a mouse, and associated controllers, collectively designed by a reference numeral 204, a hard disk and drive 206, and other storage devices, such as a floppy disk and drive and other memory devices, collectively designated by a reference numeral 208, and various other subsystems, collectively designated by a reference numeral 210, all interconnected via one or more buses, shown collectively as a bus 212.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

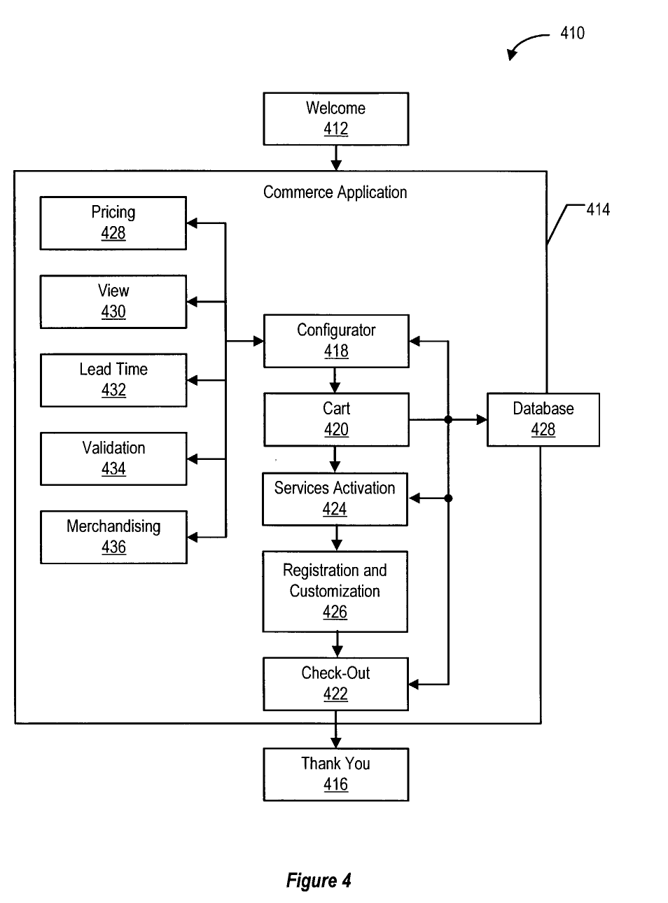

Referring to FIG. 3, when configuring a system on-line, the customer first interacts with a configurator 302 to configure a desired system. After the system is configured, the customer proceeds to a shopping cart 304. After completing the information within the shopping cart 304, the customer is provided with the option of entering registration information for services and customization information via enter registration module 306. The customer then proceeds to checkout at checkout module 308. After the customer checks out with the configured information handling system, the customer is transferred to thank you module 310 where an expression of gratitude for purchasing the system is presented. Alternately, if the customer elected to not enter registration information, then the customer is provided with another opportunity to enter registration information for services and customization information at thank you module 311.

If the customer indicated a desire to enter registration and customization information, then after the thank you module 310 or thank you module 311, the customer is transferred to store registration and customization module 312 during which the registration and customization information is obtained, stored and linked to the system order. After the information is stored, then when the information handling system is fabricated, the registration and customization information transfer module 314 transfers the registration and customization information to the customer's system during the software download portion of the manufacturing of the information handling system. Accordingly, the information handling system that is fabricated includes all the registration and customization information provided by the customer during the system configuration process.

Alternately, when configuring an information handling system via a telephone purchase, the customer configures the system via a customer sales representative at step 340. After configuring the system, the sales representative then presents the option of entering registration and customization information onto the system via module 342. The sale to the customer then completes at step 344. If the customer indicated a desire to enter registration and customization information onto the system, then the representative obtains this information via module 342. This information is then stored and linked to the order via module 312 and the registration and customization information is transferred to the individual system via module 314.

Examples of registration information that are provided by the customer include services to which the customer is registered, either during the order process or before the order process stared. For example, if a customer already had an internet provider, the information relating to the internet provided could be added to the system configuration so that when the system is received by the customer all of the necessary set up requirements are preloaded on the system. Examples of customization information that are customized by the customer include pre-configuration of application programs, screen appearance, display options etc. In this way when the customer starts up the system, the screen presentation is as the customer desires and the program options are as the customer desires.

Referring to FIG. 4, an on-line store is a component of an Internet website to which a customer may go to configure a particular information handling system, for example, according to desired options of the customer. An on-line store is one example of a system configuration store 110. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

An on-line store 410 for use in generating customer configured information handling systems, e.g., customer configured computer systems, is shown. The on-line store 410 includes a welcome or introductory module 412, a commerce application module 414, and a thank you module 416. The on-line store 410 includes an on-line store user interface which enables the system configuration, pricing, and ordering of an information handling system via the Internet. The commerce application 414 includes a configurator 418, shopping cart 420, a checkout module 422, a services activation module 424, a registration and customization module 426 and database 428. The database 428 provides information to the configurator 418, shopping cart 420, checkout module 422, services activation module 424 and registration and customization module 426. The configurator 418 includes a pricing module 428, a view module 430, a lead time warning module 432, a validation (or compatibility) warning module 434, and a merchandising module 436. The various modules of the configurator 418 are driven by data from the database 428, and thus the configurator 418, shopping cart 420, checkout module 422 and services activation module 424 are all linked to the database 428.

In operation of the on-line store 410, the welcome module 412 presents a welcome page 412, the configurator 418 presents a configurator page, the shopping cart 420 presents a shopping cart page, the checkout module 422 presents a checkout page, the services activation module 424 presents a services activation page, the registration and customization module 426 provides a registration and customization page and the thank you module 416 presents a thank you page. The welcome page includes a static page and generally resides outside of the commerce application 414. The configurator page, shopping cart page, checkout page, services activation page and registration and customization page are within the commerce application and use information provided by the database. The checkout includes a payment feature, delivery feature, personal versus business feature, and instructional text features (i.e., how to fill out an on-line form.)

The welcome page is typically an introductory page and includes a link into the on-line store 410. The welcome page is typically a static welcome page. Upon completion of configuration of a system, is transferred to a services activation page in which the customer is provided an opportunity to activate various services such as internet service or content services such as music services. After completion of the services activation, the customer is transferred to the registration and customization page. After completion of the registration and customization, the customer is transferred to a checkout page. After completion of the checkout, the customer is transferred to a static thank you page. The thank you page provides a message of gratitude to the customer for having placed the order or for visiting the on-line store.

Aspects of the configurator 418 which interact with database 428 are shown in FIG. 4. In essence, the entire commerce application 414 interacts with the database. The configurator 418, shopping cart 420, checkout module 422, services activation module 424 and registration and customization module are each part of the commerce application 414 and interact with the database 428. For example, with the shopping cart 420, additional merchandising information associated with a particular system which has been configured and placed in the shopping cart by an on-line store customer can be provided.

Also for example, various services may be provided for order by the customer by the services activation module 424 based upon the type of system ordered as well as components that are included within the system ordered. Additionally, by providing the services activation module within the commerce application 414, the customer continues the experience a similar customer experience and the system provider is able to use the information from the database 428 and to maintain control over the customer contact. By maintaining control over the customer contact the system provider is able to determine what services are activated and to maintain accurate and up to date records of the service activation.

When a purchase is processed via the telephone, then the customer representative interacts with a system similar to configurator 418.

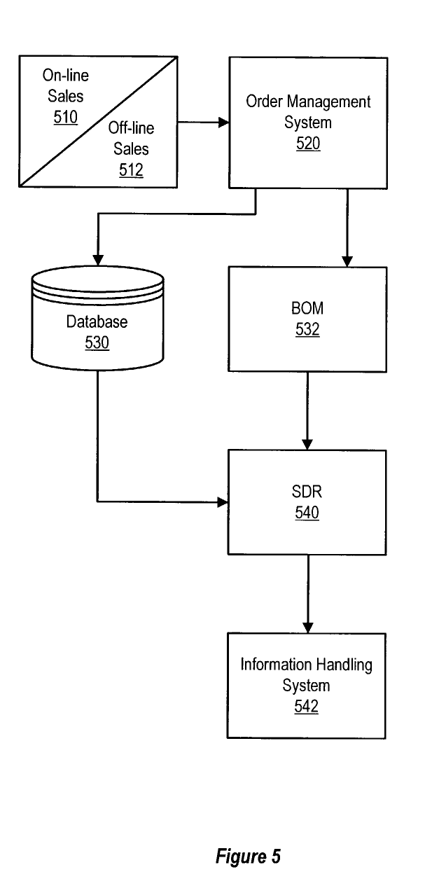

Referring to FIG. 5, when registration or customization information is obtained either via on-line sales 510 or via off-line (e.g., telephone) sales 512, the information is provided to an order management system 520 which interacts with the factory in which the system is manufactured. The order management system 520 stores this information to a database 530 as well as to a Bill of Materials (BOM) 532 which is associated with a particular system being manufactured. It will be appreciated that one or both the database 530 or the BOM 532 may be used to transfer the information from the customer order to a particular information handling system. The information is then stored in a system descriptor record (SDR) which is stored on the memory of the information handling system 542 being manufactured. Accordingly, the registration or customization information that is obtained from the customer is stored on the system that is manufactured for that customer.

Other Embodiments

Other embodiments are within the following claims.

For example, it will be appreciated that the order in which the customer is presented with the services activation page, the registration and customization page and check out page may vary. E.g., the customer may checkout before accessing the services activation page. Alternately, the services activation module may not be presented at all.

What is claimed is:

1. A system for preconfiguring an information handling system comprising:
a configurator, the configurator configuring a system with options selected according to user input;
a registration and customization module, the registration and customization module obtaining information relating to registration and customization for the information handling system;
a store registration and customization information module, the store registration and customization information module storing the information relating to the registration and customization on the information handling system; and,
a database, the database receiving information from and supplying information to the configurator, the registration and customization module and the store registration and customization information module.

2. The system of claim 1 wherein:
the information relating to registration and customization information is pre-loaded onto the information handling system when the information handling system is fabricated.

3. The system of claim 1 wherein:
the configurator and the registration and customization module provide a customer with a consistent customer experience.

4. The system of claim 1 further comprising
a service activation module, the service activation module enabling a user to activate services based upon the options selected according to user input, the activated services then providing registration information.

5. The system of claim 1 wherein
the registration information is obtained on-line.

6. The system of claim 1 wherein
the registration information is obtained via the telephone.

7. A method of preconfiguring an information handling system comprising:
configuring a system with options selected according to user input; obtaining information relating to registration information for the information handling system;
storing the information relating to the registration information in a database; and,
loading the information relating to registration information from the database onto a particular information handling system while fabricating the particular information handling system.

8. The method of claim 7 wherein:
the configuring and the obtaining registration information provide a customer with a consistent customer experience.

9. The method of claim 7 further comprising
enabling a user to activate services based upon the options selected according to user input, the activated services having corresponding registration information.

10. The method of claim 7 wherein
the registration information is obtained on-line.

11. The method of claim 7 wherein
the registration information is obtained via the telephone.

12. A system configuration store for preconfiguring an information handling system comprising:
means for configuring a system with options selected according to user input;
means for obtaining information relating to registration information for the information handling system;
means for storing the information relating to the registration information in a database; and,
means for loading the information relating to registration information from the database onto a particular information handling system while fabricating the particular information handling system.

13. The system of claim 12 wherein:
the means for configuring and the means for obtaining registration information provide a customer with a consistent customer experience.

14. The system of claim 12 further comprising
means for enabling a user to activate services based upon the options selected according to user input, the activated services then providing registration information.

15. The system of claim 12 wherein
the registration information is obtained on-line.

16. The system of claim 12 wherein
the registration information is obtained via the telephone.
